(19) United States
(12) Patent Application Publication
(10) Pub. No.: US 2020/0300800 A1
(43) Pub. Date: Sep. 24, 2020

(54) Electrochemical Detection without Reagents

(71) Applicant: Shobhan Paul, Malibu, CA (US)

(72) Inventor: Shobhan Paul, Malibu, CA (US)

(21) Appl. No.: 16/827,204

(22) Filed: Mar. 23, 2020

Related U.S. Application Data
(60) Provisional application No. 62/822,972, filed on Mar. 24, 2019.

(51) Int. Cl. G01N 27/31; G01N 27/38; C02F 1/44

(52) U.S. Cl. CPC G01N 27/31; G01N 27/308; C02F 1/441; G01N 27/38

(57) ABSTRACT

An electrochemical method for analyzing the presence of certain analytes in a fluid in concentrations as low as parts per trillion without use of reagents. This is done by using a combination of filtration, microfluidics, increasing the electrochemical gradient, while reducing double layer capacitance, the Nernst layer and other methodologies discussed below. Such a method can be used to get data on certain pollutants like heavy metals in real time and then through internet of things send the data to the Cloud. Such a methodology would help form a nervous system for the planet, wherein pollutants are monitored in real time.

### PRIORITY CLAIM

This application claims the benefit of priority to U.S. Provisional Application No. 62/822,972 filed on Mar. 24, 2019, the contents of which are incorporated herein by reference.

### FIELD OF THE INVENTION

This invention relates to electrochemical analysis without reagents for monitoring pollution.

### BACKGROUND OF THE INVENTION

Disasters like those that occurred in Flint, Mich. reaffirmed the importance of monitoring pollutants in the environment. Current methods of electrochemical analysis require sensitive, expensive sensors that require frequent maintenance to detect lead (Pb)—the contaminant that caused the problems in Flint. This invention enables detection in the field or even remotely of analytes at concentrations as low as parts per trillion, well below EPA guidelines. Furthermore, since no reagents need to be added, it is better from an environmental, maintenance, durability and end user standpoint.

Currently nanosensor electrodes are available but they have not been integrated into sensor systems that enables detection of analytes at concentrations as low as parts per trillion without using reagents. Nor has the work been done to increase the electrochemical gradient, reduce double layer capacitance or decrease the Nernst layer, prevent fouling of the electrodes, reduce edge effects and ensure that the working electrode does not passivate. Here sensor arrays are used as the working electrode and the counter electrode is kept very close and the fluid to be analyzed are all put together to increase the electrochemical gradients. The analytes, especially heavy metals are detected at concentrations as low as parts per trillion in very low conductivity fluids without reagents. This technology can be combined with wireless communication means and the IOT (Internet of Things) to give real time snapshots of pollution without the use of reagents.

A major limitation of microelectrodes or nanoelectrodes is that they are very vulnerable to fouling and/or contamination. This problem is solved in the present invention by utilizing multiple filtration methods and a reducing the amount of fluid required for analysis. It is axiomatic that the reduction of the fluid to be tested results in a drop of impurities contacting the sensors. Additionally, a protocol was developed to clean the electrodes thoroughly without any reagents. Other users of nanoelectrodes use reagents to clean the electrodes.

### BACKGROUND ART

U.S. Pat. No. 5,670,031 discusses microfluidics but requires the use of reagents.
U.S. Pat. No. 6,110,354 Discloses related concepts in microfluidics, but requires the use of reagents and can only detect concentrations in the high part per billion range. The present invention detects contaminants in concentrations as low as parts per trillion.
U.S. Pat. No. 6,790,341 requires the use of reagents for detection.
U.S. Pat. No. 7,625,469 discloses technology developed at Sandia Laboratory. The disclosed invention required the use of reagents and was limited to very low scan rates to minimize capacitive currents, thus reducing the analytes signal. Further, the patent addressed electrode size but did not indicate as to how the electrochemical gradients could be maximized. Another problem was the fouling of the sensors and their passivation, a problem overcome by the current invention.
U.S. Pat. No. 7,435,386 discloses biosensors where the biorecognition element requires an analog of the analyte to be detected in order to operate.
U.S. Pat. No. 8,758,584 Is solely a pH sensor and will not work for analytes such as cations.
WO2019US12514 Requires PH adjustment and used acids or bases for pre-treatment and cleaning. The present invention requires only water for pre-cleaning.
U.S. Pat. No. 10,191,009 fails to measure below one part per billion, which is not acceptable for many pollutants such as mercury. Further, the technology has a high degree of error. The disclosed invention does not explain how to handle the low conductivity of natural waters. Electrochemical gradients as the driving force. See Reference Physical Electrochemistry by Eliezer Gileadi, Eq 2.4, page 9
S. Srinivasan, Fuel Cells, From Fundamentals to Applications, Springer eBooks, 2006, ISBN 978-0-387-35402-6,[1] Download CHAPTER 2, ELECTRODE/ELECTROLYTE INTERFACES: STRUCTURE AND KINETICS OF CHARGE TRANSFER

### Nanosensors for Detecting Pollutants in Water by Shobhan Paul: Ceramic Transactions Volume 265

Integration of a surface acoustic wave biosensor in a microfluidic polymer chip Biosensors and Bioelectronics 22 (2006) 227-232 Kerstin Lange, Guido Blaess, Achim Voigt, Reiner Gotzen, Michael Rapp

### Objects of the Invention

It is an object of the invention to provide a method and apparatus that can detect analytes using electrochemical means without the use of reagents.
It is a further object of the invention to provide a method and apparatus that can be located remotely and has little required maintenance for repeated operation.
It is a further object of the invention to provide a sensor comprised of nanopores that are comprised of a working electrode, counter electrode and reference electrode.
It is a further object of the invention to filter fluid to be tested through multiple filters to reduce particulate contamination.
It is a further object of the invention to transmit fluid samples to the nanopore array using a pump and/or microfluidics.
It is a further object of the invention to provide a sensor that can be connected to the internet through the cloud using cellular technology.
It is a further object of the invention to provide working and counter electrodes constructed out of porous material.
It is a further object of the invention to construct the sensor electrodes out of a low passivation material the group of materials including graphene, doped graphene, titanium dioxide, graphite, carbon, doped carbon, iridium oxide, tin oxide, polymers mixed with CNT or other polymers, including hybrids.
It is a further object of the invention to use a scan rate that is optimized to reduce the double layer capacitance and maximize the non-linear response of the nanopores.
It is a further object of the invention where the method and apparatus include a cleaning method that includes cycling the potentiostat connected to said electrodes between 10 and 100 times at very high scan rates between 100 microvolts/sec and 1 volt/sec, holding the potentiostat at an oxidation potential ranging from between 200 mv and 1000 mv and passing a stream of water filtered by reverse osmosis over the sensor.

### SUMMARY OF THE INVENTION

It is an object of the invention to provide an electrochemical sensor/system which makes electrochemical detection of heavy metals and other analytes possible without the use of reagents. The fluid to be tested is passed through a fine mesh non-metallic filter to remove impurities before testing. This step prevents the sensors from becoming clogged and increases their useful service life.

The present invention solves this problem by increasing electrochemical gradients to enhance transport of ions—in case of metals—cations to the working electrode while utilizing the additional improvements: using a porous anode while maintaining the distance between the electrodes from less than 1 micron to 1 cm, using a porous cathode while maintaining the distance between the electrodes from 1 micron to 1 cm, positioning the electrodes so they do not act as parallel plate capacitors.

In another preferred embodiment, a rotating electrode is utilized to increase diffusion. Piezolectrics and/or microfluidics are used in another embodiment to increase fluid flow, stir the solution to reduce Nernst layer and increase diffusion. In another embodiment the non-linear response of the nanopores is used to increase the scan rates, while ensuring the double layer capacitance currents remain negligible.

The new generation of proposed nanopores have diameters ranging from 50 nanometers to 1 micron and will be impacted minimally by capacitive currents. These novel nanopores also provide an improved signal to noise ratio. Further, the disclosed nanopores will have enhanced mass transport, due to dominance of radial diffusion, decreased charging currents and decreased deleterious effects of solution resistance. The present invention enables new applications of ultra-small electrochemical systems. As electrodes decrease in size, radial (3-dimensional) diffusion becomes dominant and results in faster mass transport. This high rate of mass transport (diffusion) at small electrodes enables measurement of kinetics by steady-state experiments rather than by transient techniques. In principle by decreasing electrode size from micrometer to nanometer scale, study of faster electrochemical and chemical reactions should be possible. This is because the electron transfer process is less likely to be limited by the mass transport of reactant to the electrode surface at very high rates of mass transport. In another embodiment low passivation materials are used that increase the service life of the nanopore constructed sensors. These materials include graphene, doped graphene, titanium dioxide, graphite, carbon, doped carbon, iridium oxide, tin oxide, polymers mixed with CNT or other polymers, including hybrids. Clear positive test results are shown with lead detection in very low conductivity water from a reverse osmosis system.

In another embodiment, different materials are used for reference electrodes.

In another embodiment this invention is used submerged to test for heavy metals and other analytes without bringing the samples to the surface of the body of water. In another embodiment this invention is used to test air quality for hexavalent chromium and other analytes. In another embodiment digital filtering is used to improve analysis. In another embodiment the detection scans are limited to different potential ranges to minimize overlap and overloading of the sensors.

### BRIEF DESCRIPTION OF THE DRAWINGS

FIG. 1 shows a block diagram of the components of the claimed invention.

FIG. 2 shows a diagram of the filter used in the claimed invention.

FIG. 3 shows a cross section of the sensor with a non-porous counter electrode.

FIG. 4 shows a cross section of the sensor with a porous counter electrode.

FIG. 5 shows a the relationship between Faradic and Capacitive Currents.

FIG. 6 shows the non-linear nanopore response based on scan rate.

FIG. 7 shows current leakage from unprotected edges of a chip.

FIG. 8 shows chip with a dielectric material blocking current leakage.

FIG. 9 shows a protective edge formed using 3d printing.

FIG. 10 shows the improved lead detection capability of the claimed invention.

FIG. 11 shows a block diagram of the computer used for analysis with the claimed invention.

### DETAILED DESCRIPTION OF THE INVENTION

Nanosensors as described in the current art are vulnerable to contamination, need constant maintenance and as such not suitable to usage in remote, unmanned locations for environmental monitoring. The present invention claims a variety of improvements that allow detection of various analytes in a fluid or a gas (such as the atmosphere) including mercury, lead, cadmium, chromium, hexavalent chromium and other dangerous substances without the use of reagents. Additionally, the present invention includes novel method and apparatus that prevent contamination of the sensors so that these sensors can be left unmanned, without maintenance, in remote locations for testing water or the atmosphere, for long periods of time to transmit detection of dangerous substances to a central location, and act as a nervous system for the planet.

FIG. 1 shows a block diagram of a preferred embodiment of the apparatus configured to practice the claimed method. Remote sensor 10 is comprised of the elements shown in the block diagram. Test sample collector 1 is used to collect a sample from the fluid or gas to be analyzed. In the preferred embodiment, this is a chamber that's designed to capture a set amount of a fluid by being submerged in the fluid, as with a lake, stream, river, aquifer, ground water, reservoir or other body of water. Other types of test sample collection methods can be used such as a dropper, syringe, beaker or capillary tubes. The claimed invention can also capture samples of atmospheric gas to test for contaminants. Once a sample is collected, it is passed through filter 2, which described in greater detail below. Once filtered, pump 3 passes the fluid sample into test chamber 6 and over sensor array 9. The pump 3 could be a syringe pump, peristaltic pump, pressure driven pumps with or without flow meters. Alternately or in combination with the above microfluidic channels made via lithography or custom 3D printed mirofluidic devices and or 3D printed microfluidic devices using machined reservoirs—where the machined reservoirs are connected via soft tubing to the filter 2.

Sensor array 5 is comprised on a plurality of sensors 5, each comprising a nanopore working electrode, counter electrode and reference electrode. The sensor array 5 will be shown in additional detail in FIG. 3. In the preferred embodiment, potentiostat 4 is used to provide and measure appropriate voltages and currents that enable deposition, stripping and identification of analytes from the sensor array. Potentiostat 4 is connected to sensor array via working electrode connection 11, counter electrode connection 12 and reference electrode 13. Wireless Internet Connected Computer 7 is used to analyze the results captured from the potentiostat and send results to a central location via the cloud, wide area network or cellular internet connection. Fluid sample exits the sensor via discharge 14.

FIG. 2 shows the filter 2 of the present invention in detail. The sedimentary filter 15 will remove most of the debris and fine particles. The next filtration state is a fine mesh filter for further cleaning, such a filter would capture contaminants like E. coli bacteria. Both sedimentary filter 15 and fine mesh filter 16 must be constructed of non-metallic materials to prevent ions shed by metallic filters from flowing into the test chamber. Electrochemical oxidation chamber 17 is used in the preferred embodiment to further break down organics, including metals bound in organic complexes.

FIG. 3 shows a cross section of a first preferred embodiment of sensor 5. In this embodiment, counter-electrode 18 is not porous. Substrate 23 is the base layer shown in the cross section and formed of silicon in this embodiment. A working electrode 21 is formed of gold in a thickness of 20-200 nanometers, which includes an underlying layer of titanium. This layer is deposited on the silicon substrate using standard semiconductor deposition processes well known in the art. Photoresist layer 26 is deposited on top of working electrode 21 using similar deposition processes and etched using standard photolithography processes to form a plurality of nanopores 25. Microchannel 19 is formed to be a channel for the fluid to be analyzed. Dielectric layers 20 and 24 are deposited on either side of the sensor to limit current leakage through the edges of the sensor. Reference electrode 22 is formed of materials such as Ag/AgCl, titanium/gold, titanium/platinum and its use and application is well known in the art. Counter electrode 18 is disposed above microchannel 19 and formed of a non-porous material.

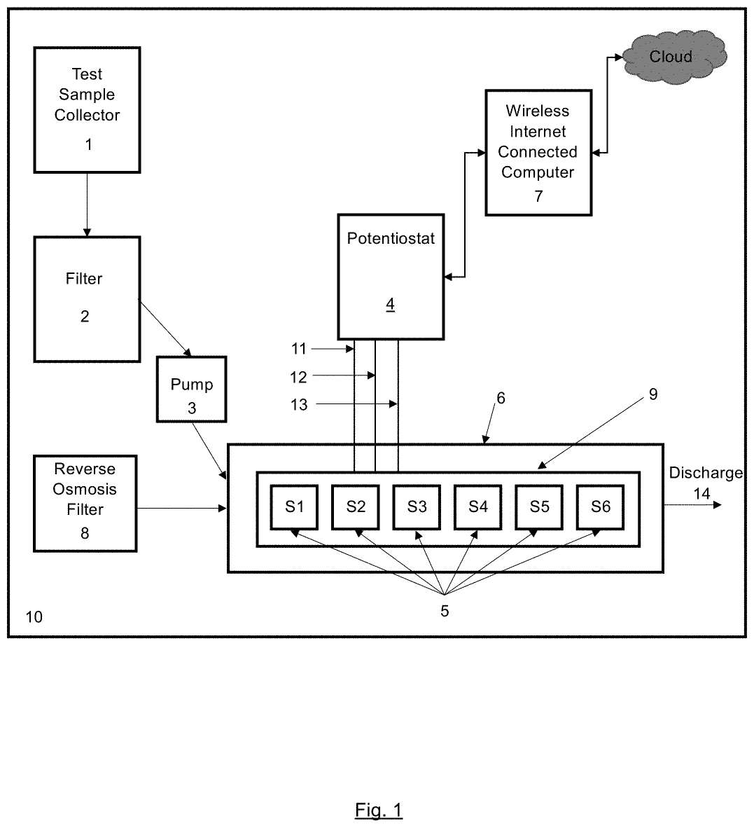

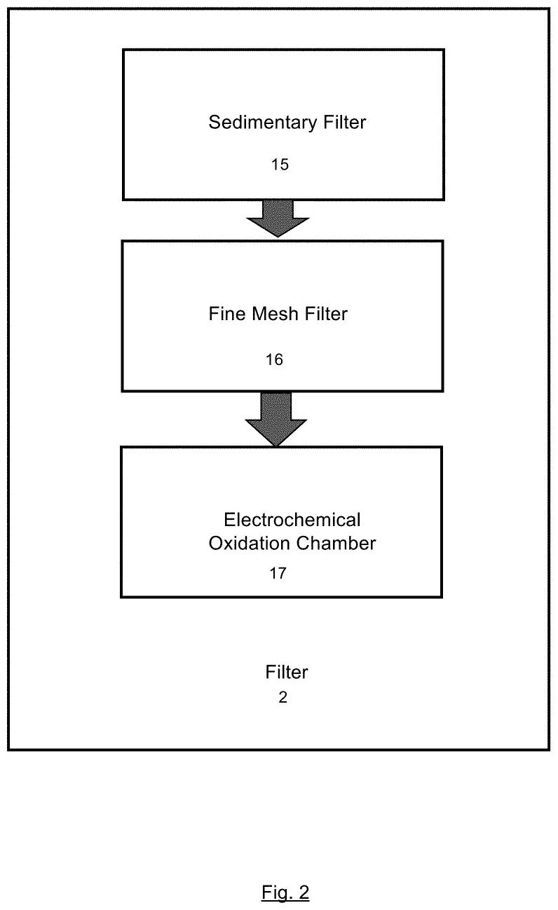

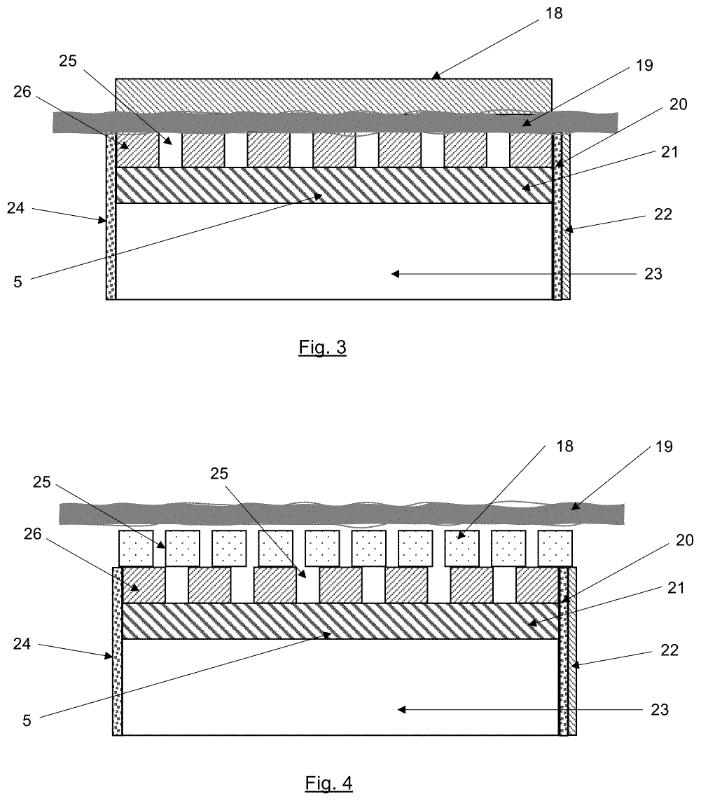

FIG. 4 is an alternative embodiment of sensor 5 with a porous counter electrode 18. As in the first embodiment, the base layer is silicon. The working electrode 21, formed gold in a thickness of 20-200 nanometers is deposited on top of a thin titanium layer which has been deposited on the silicon wafer, again with deposition methods known in the art. Photoresist layer 26 is deposited on top of conductive layer 21 using standard deposition, photolithography and etching processes to form a plurality of nanopores 25. In this embodiment, counter electrode is formed of a porous material, such as such as graphene, Ni-mesh coated with graphene, titanium mesh coated with graphene, and/or platinum mesh. Use of a porous material allows fluid from microchannel 19, disposed above the porous counter electrode, to be in contact with working electrode 21.

The following discussion outlines the physics related to the geometry of the nanopore sensors necessary to practice the claimed invention. The first equation below shows how the current density relates to the Nernst diffusion layer thickness and scan rate. The decrease of dimensions of a microchannel lead to a decrease in the thickness of the Nernst layer as outlined in Biosensors and Bioelectronics 22 (2006) 227-232 Kerstin Lange, Guido Blaess, Achim Voigt, Reiner Gotzen, Michael Rapp.

### Reducing the Nernst Diffusion Layer

The present invention enhances chemical diffusion by ensuring a very small distance between the working electrode and the outermost point of the fluid being tested.

The equation below calculates current density:

$${J}_{d} = \frac{n F D {C}_{b}}{r} ⌈ \frac{1}{{( π D t )}^{1 / 2}} + \frac{1}{r} ⌉$$

Where J_{d}=current density
n=number of electrons transferred per molecule
F is Faraday's number
C_{b}=Bulk concentration
D is the co-efficient of Diffusion
t is the time lapsed see Gileadi, Eliezer, Physical Electrochemistry, Page 214, equation 14.46.
The expression (πDt)^{1/2} is the Nernst diffusion layer thickness δ
t is the inverse of the scan rate—at higher scan rates the diffusion layer is smaller while at low scan rates the diffusion layer is longer.

In this invention the Nernst diffusion layer is reduced by using a microchannel 19 of very small height 50-500 microns.
J_{L=limiting current density=}nFDC_{b}/δ See Gileadi, Page 4, equation 1.7.
   With a thinner Nernst layer, the molecules in the bulk fluid need less time to pass through the layer and reach the sensor surface see Biosensors and Bioelectronics 22, Page 232. Another advantage of reducing the Nernst layer is that with D/δ equaling the specific rate of diffusion, reducing the Nernst layer drastically, the rate of diffusion increases thus making sensor 5 more sensitive and quicker.

In the current state of the art as disclosed in U.S. Pat. No. 7,625,469, the current becomes independent of time only after the passage of significant time.

$${J}_{d} = \frac{n F D {C}_{b}}{r}$$

See Gileadi, Page 214, equation 14.47.
The other benefit is that due to the shorter times there is less fouling of the sensor 5 by particulates and debris.

### Increasing the Electrochemical Gradient

The present invention drives ions towards working electrode 21 by using a small distance between working electrode 21 and counter electrode 18. Counter electrode 18 or working electrode 18 is constructed of a porous material, such as graphene, Ni-mesh coated with graphene, titanium mesh coated with graphene, and/or platinum mesh, so that the chemical diffusion does not get reduced. The electrochemical gradient increases as the distance between working electrode 21 and counter electrode 18 decreases.

The electrochemical gradient is given by the Nernst-planck equation

$$J = - D [ {Δ}_{c} + \frac{z F}{R T} c Δ φ ]$$

The first part of the equation is the chemical gradient and the 2^{nd} part is the electrostatic gradient. The chemical gradient drives the analyte ions to the working electrode 21. Flux of the analyte ions J mol.

$${m}^{- 2} s e {c}^{- 1} = - D \frac{d c}{d x}$$

where D is the diffusion coefficient and dc/dx is the concentration gradient.

From the above equation, it is shown that reducing the area of working electrode 21 decreases the amount of flux coming to it, in turn reducing the signal, which is not desirable. Thus a non-porous counter electrode on top of the working nanopore electrode is self-defeating, as it blocks the chemical diffusion. Hence it is important to either have a porous counter-electrode 18 above it as shown in FIG. 3, or to have a very thin layer of fluid between the working electrode 21 and the counter electrode 18 as shown in FIG. 4.

The electrostatic gradient is stronger the closer the working electrode 21 and counter electrode 18 are to each other. In the preferred embodiment, the working electrode 21 and counter electrode 18 are separated by a distance from 1 micron to 1 cm. At this distance, the working electrode 21 and counter electrode 18 may start behaving like parallel plate capacitors, to avoid this, the invention makes sure that the current from the counter electrode is driven a direction perpendicular to that of the working electrode. Earlier patents do not address this problem. The cited Nernst-Planck equation is well known in the art and describes this approach.

### Reducing Capacitive Currents

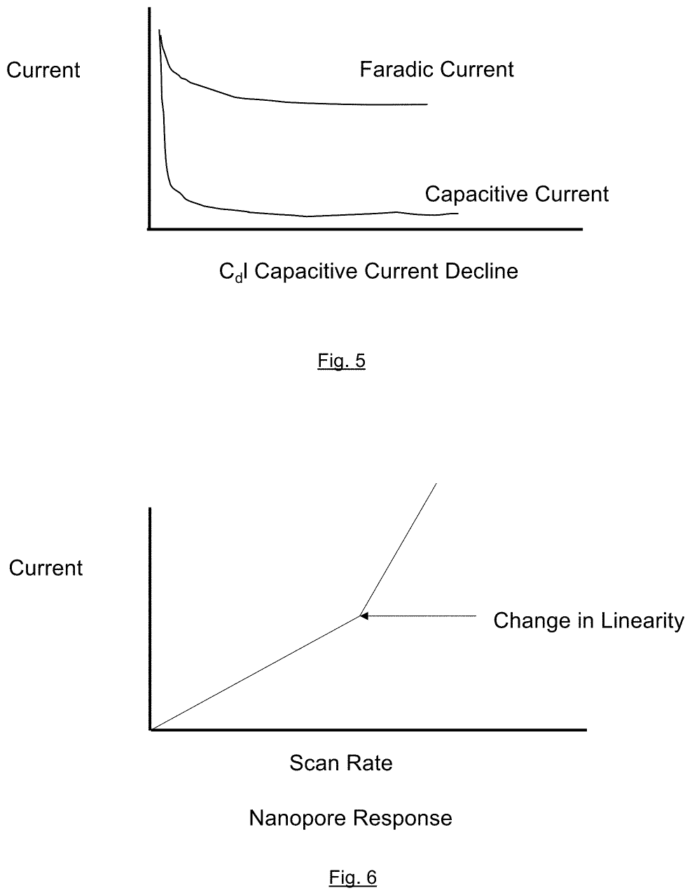

In Electochemical testing there are two types of currents generated, one Faradic and the capacitive due to the double layer surrounding electrodes. The faradic currents are generated due to electrochemical reactions—oxidation or reduction. See FIG. 5

The capacitive current, caused by physics, is an unwanted side effect. The cause of this current is ions accumulating in front of the electrode. These ions and the electrode's charged surface form a capacitor. If the potential of the electrode is changed, for example during a potential step, the amount of charge the capacitor sores changes and a current will flow that has no chemical but only a physical meaning. This is the current that charges or discharges the capacitor also known as capacitive charging current or short capacitive current. This current decays exponentially with time. Nanoelectrodes have historically been restricted to low scan rates, especially when dealing with low conductivity solutions like drinking water. In order to reduce capacitive currents, working electrode 21 and counter electrode 18 of diameter 0.50 nm to 2 micron are used. Double layer capacitance is calculated:

C_{dl}=εA/d.

Here C_{dl} double layer capacitance, ε is the dielectic constant, A is the area—for circular areas A=πr². An electrode of 0.25 micron will have 1/16^{th} the capacitance of a 1 micron electrode. Using smaller working electrodes 21 and counter electrodes 18 will allow faster scan rates. There is an added benefit of these nanopores: after a certain scan rate the current is no longer linear. A unique non-obvious feature of this invention is the ability to use a non-linear scan rate. See FIG. 6. Higher scan rates provide more current. There has to be balance between the capacitive current decline and the scan rate. The capacitive current dies over time and are much more short lived than faradic currents. At low scan rates they get more time to die off while at high scan rates they don't get enough time, so the signal achieved is more contaminated by the capacitive current. In this invention, by reducing the size of the nanopore 25, the capactive currents are greatly reduced and higher scan rates are possible.

### Reducing Edge Effects

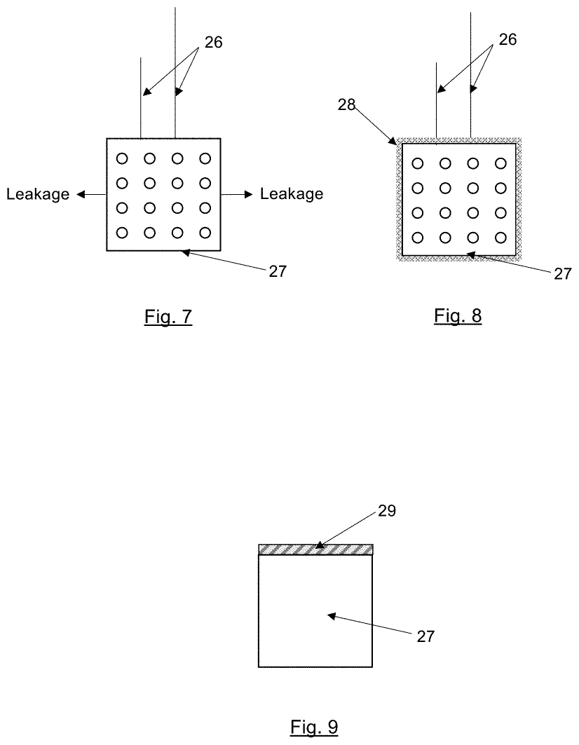

A big problem in the industry are the ‘edge effects”. Many nanosensors leak current from the edges of the chips 27 as shown in FIG. 7.

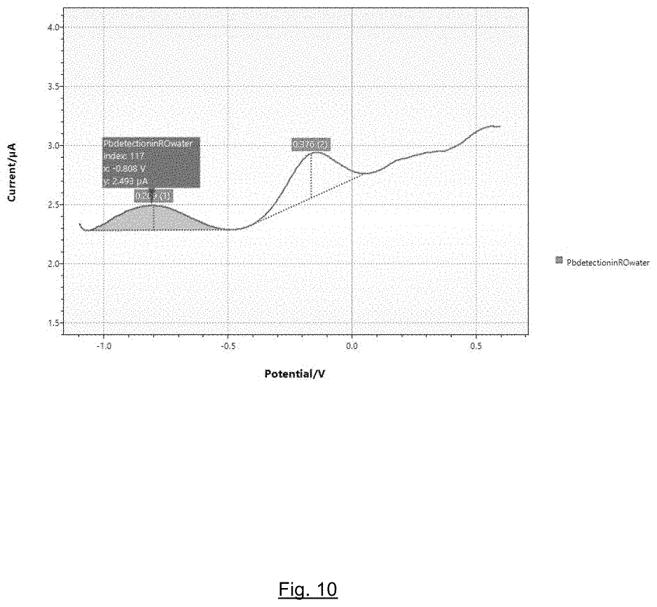

In the preferred embodiment, shown in FIG. 8, it is disclosed to put dielectric 28 at the edges of the chip 27. In the current state of the art, it is quite common use expensive gold wire bonding. In the preferred embodiment, the need for gold wire bonding is removed. FIG. 9 shows using 3d fabrication to create edge 29 such that no fluid touches the connecting pad. Because of this feature, and the far smaller volumes of fluid used, cheaper connections like conductive tape can be used.

### Repeatability and Increasing Lifespan

The present invention is designed to have a long life and to be used in remote locations with limited maintenance. To achieve this goal, the sensors must be able to be used repeatedly and as such must be clean. The preferred embodiment of the invention includes a cleaning protocol to achieve longer sensor life by reducing/removing oxidation and particulate contamination. The cleaning cycle includes running includes running stripping and oxidation cycles in RO water.

Wireless internet connected computer 7 processes the last scan to determine if the current levels shown by oxidation are in the picoamp range to determine if chip is clean. The final cleaning scan is performed by a short oxidation at about 200 mv for 25 secs. After the cleaning protocol is complete, the sensor 5 can be used for analyte testing again. This is a vast improvement over prior art cleaning methods which use acid. Acid is both dangerous for the planet, consumable (and thus requires maintenance) and reduces the sensor life.

### Increasing Lifespan

A nervous system for the planet requires sensors 5 than can repeatably perform their analysis over a long lifespan, in harsh environments and with minimal to zero maintenance by humans. Sensors manufactured of gold (au) and other materials tend to passivate after use. The alternative approach used in the preferred embodiment of this invention is to use a non-metal for the working electrode 21. Exemplary materials include: Titanium dioxide (anastase), graphene, certain forms of carbon, doped materials, iridium oxide, polymers mixed with CNT (Carbon Nanotubes), or other polymers, including hybrids, like graphene doped with other materials. Multiple tests with graphene have shown that it can function without passivation. Graphene can first be deposited on a wafer and then using standard deposition, etching and lithography processes nanopores can be formed.

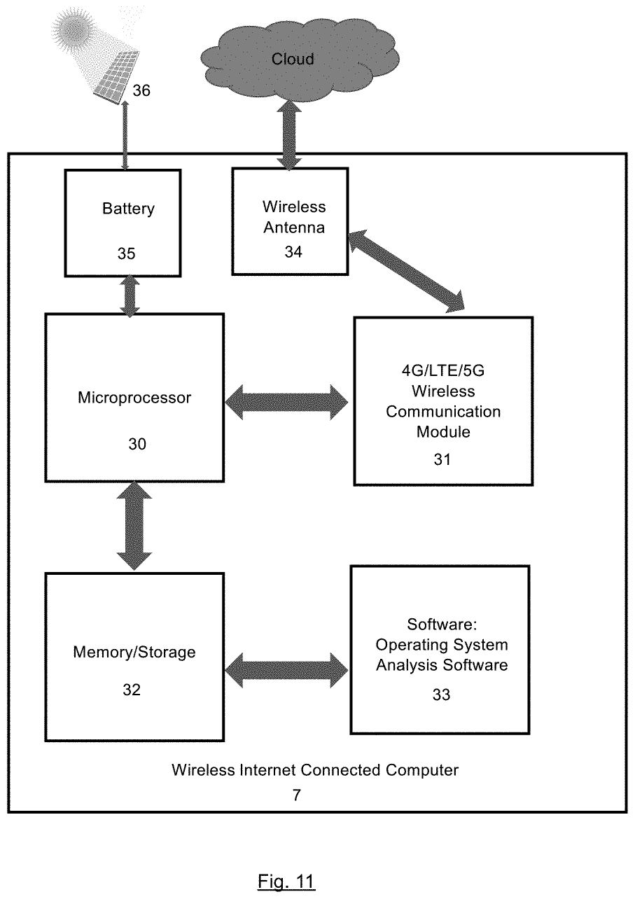

FIG. 10 shows test data performed with the claimed invention, detecting lead (Pb) in very low conductivity water. This was detection of 1.33 ppb lead in very low conductivity reverse osmosis water of a conductivity of 30 μSiemens/cm without reagents.

FIG. 11 is a block diagram of the components wireless internet connected computer 7. Microprocessor 30 can be chosen from any number of industry standard microprocessors manufactured by Intel, AMD and ARM. Microprocessor 30 runs the software 33 which includes the operating system and analysis software that is connected to outputs of potentiostat 4 (not shown). Any appropriate operating system can be utilized for the disclosed invention, including those from Microsoft (Windows), Apple (macOS and iOS) and Google (Android). Mobile operating systems such as iOS and Android may be preferable due to their integrated mobile functionality. Memory/storage 32 includes random access memory for the microprocessor and solid state storage such as Flash memory for storing software 33. In the preferred embodiment, wireless communication module 31 is connected to the internet (and thus the cloud) using standard wireless communication protocols such as 4G/LTE and 5G networks. Wireless communication module 31 is connected wireless antenna 34 to connect to the wireless network. In the preferred embodiment, battery 35 is connected to solar panel 36. This arrangement allows the unit to be located off the grid and to recharge its own battery. The battery can be made up of industry standard lithium ion cells or other appropriate compositions.

Although the present invention has been described in relation to the above disclosed preferred embodiment, many modifications in design, materials and manufacturing are possible while still maintaining the novel claimed features and advantages of the invention. The preferred embodiment is not meant to limit the claims in any way, and the claims should be given the broadest possible interpretation consistent with the language of the disclosure on the whole.

1. A method of analyzing the presence of a analytes in a fluid in concentrations as low as parts per trillion without use of reagents, the steps comprising:
Identifying a test sample from a fluid to be tested,
Removing organic material and impurities from the test sample at least one filter,
Transmitting the test sample to a test chamber via a sample transmission means,
Passing the test sample over a plurality of sensors; each sensor comprising a working electrode comprising nanopore material, a counter electrode and a reference electrode and where the nanopores are arrayed at a set distance,
Depositing the analyte of interest on the sensors while holding said working electrode at a potential that is suitable for deposition of said analyte,
Stripping the deposited analyte from said working electrode using voltammetric methods, Measuring the peak current,
Analyzing the peak current to determine the analyte deposited.

2. The method of claim 1 where the sample transmission means is a pump or microfluidics or a combination of both a pump and microfluidics.

3. The method of claim 1 where the filter is a combination of a sedimentary filter, a non-metallic micron filter with a mesh size from 0.2 microns to 25 microns and an electrical pulse generator to break down organic material.

4. The method of claim 1 where the distance between the nanopores is between 250 nanometers and 10 microns.

5. The method of claim 1 where the distance between the nanopores is between five times the diameter of the nanopores to 20 times their diameter.

6. The method of claim 1 where the peak current is measured using a potentiostat and the analysis of the peak current is performed by a computer comprising a microprocessor, memory for storage, and wireless internet connected communication means for sending data to a location other than the location of the analysis.

7. The method of claim 1 where the counter electrode and working electrode are porous.

8. The method of claim 1 where the sensors are constructed different combinations of materials for each of the working electrodes, counter electrodes and reference electrodes and said sensors can be addressed individually.

9. The method of claim 1 where the direction of the current from the counter-electrode is driven in a direction perpendicular to the direction of the current from working electrode to prevent the electrodes from acting as parallel plate capacitors.

10. The method of claim 1 where measuring the peak current includes a scan rate and where said scan rate is optimized to reduce the double layer capacitance and maximize the non-linear response of nanopores.

11. The method of claim 1 where the lifespan of the electrodes is increased by constructing said electrodes of a lower passivity material from the group of materials including graphene, doped graphene, titanium dioxide, graphite, carbon, doped carbon, iridium oxide, tin oxide, polymers mixed with CNT or other polymers, including hybrids.

12. The method of claim 1 where the electrodes are cleaned by;
Cycling a potentiostat connected to said electrodes between 10 and 100 times at very high scan rates between 100 microvolts/sec and 1 volt/sec, and
Holding said potentiostat at an oxidation potential ranging from between 200 mv and 1000 mv and passing a stream of water filtered by reverse osmosis over said sensor.

13. An apparatus for measuring the presence of one or more analytes in a fluid in concentrations as low as parts per trillion without use of reagents, comprising:
A transmission means for transmitting a test sample to a test chamber for performing the analysis on a test sample,
One or more filters for removing organic material and impurities from the test sample before the test sample is transmitted to the test chamber,
A sensor located within the test chamber, each sensor comprising a working electrode constructed of nanopore material, a counter electrode and a reference electrode and where the nanopores are arrayed at a set distance and the distance between the working electrode and counter electrode ranges from 0.5 microns to 1 cm,
A potentiostat for holding the working electrode at a potential that is suitable for deposition of said analyte on said sensors, for measuring the peak current at the working electrode during stripping of the deposited analyte from said sensors using voltammetric methods and producing voltammograms of said peak currents,
A computer for analyzing said voltammograms and identifying the oxidation/reduction potential at which the analyte deposited.

14. The apparatus of claim 14, where the sample transmission means is a pump or microfluidics or a combination of both a pump and microfluidics.

15. The apparatus of claim 14, where the filter is a combination of a sedimentary filter, a non-metallic micron filter with a mesh size from 0.2 microns to 25 microns and an electrical pulse generator to break down organic material.

16. The apparatus of claim 14 where the distance between the nanopores is between 5 times the diameter of the nanopore to 20 times the diameter of the nanopore.

17. The apparatus of claim 14 where the computer comprises a microprocessor, memory for storage, and wireless internet connected communication means for sending data to a location other than the location of the analysis.

18. The apparatus of claim 14 where the counter electrode and working electrode are porous.

19. The apparatus of claim 14 where the sensors are constructed different combinations of materials for each of the working electrodes, counter electrodes and reference electrodes and said sensors can be addressed individually.

20. The apparatus of claim 14 where the direction of the current from the counter-electrode is driven in a direction perpendicular to the direction of the current from working electrode to prevent the electrodes from acting as parallel plate capacitors.

21. The apparatus of claim 14 where the potentiostat includes a scan rate and where said scan rate is optimized to reduce the double layer capacitance and maximize the non-linear response of nanopores.

22. The apparatus of claim 14 where the lifespan of the electrodes is increased by using constructing said electrodes of a lower passivity material from the group of materials including graphene, doped graphene, titanium dioxide, graphite, carbon, doped carbon, iridium oxide, tin oxide, polymers mixed with CNT or other polymers, including hybrids.

23. The apparatus of claim 14 where;
The potentiostat is capable of being cycled between 10 and 100 times at very high scan rates between 100 microvolts/sec and 1 volt/sec, and
The potentiostat is capable of being held at an oxidation potential ranging from between 200 mv and 1000 mv while passing a stream of water filtered by reverse osmosis over said sensor.
